(19) United States
(12) Patent Application Publication
(10) Pub. No.: US 2024/0289546 A1
(43) Pub. Date: Aug. 29, 2024

(54) SYNTHESIZED RESPONSES TO PREDICTIVE LIVESTREAM QUESTIONS

(71) Applicant: Loop Now Technologies, Inc., San Mateo, CA (US)

(72) Inventors: Ziming Zhuang, Palo Alto, CA (US); Edwin Chiu, Cupertino, CA (US); Shi Feng, East Palo Alto, CA (US)

(73) Assignee: Loop Now Technologies, Inc., San Mateo, CA (US)

(21) Appl. No.: 18/617,772

(22) Filed: Mar. 27, 2024

Related U.S. Application Data
(63) Continuation-in-part of application No. 18/585,212, filed on Feb. 23, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.

(51) Int. Cl. G06F 40/20; G06Q 30/0241; H04N 21/2187; H04N 21/442

(52) U.S. Cl. CPC G06F 40/20; G06Q 30/0241; H04N 21/2187; H04N 21/44218

(57) ABSTRACT

Disclosed embodiments provide techniques for synthesized responses to predictive livestream questions. A livestream featuring a host is accessed and is viewed by one or more viewers. The audio, video, and images from the livestream are analyzed and a plurality of potential questions from the one or viewers is predicted based on the analysis. An answer to each potential question is generated based on a large language model (LLM) neural network. A synthesized video segment is created for each answer generated by a generative AI chatbot linked to a LLM for each potential question. During the livestream, real-time questions from the one or more viewers are detected. The real-time questions are matched to the synthesized video segment answers and the matched synthesized video segment is rendered to the one or more livestream viewers. An ecommerce environment is rendered during the livestream to allow purchasing of products.

### RELATED APPLICATIONS

This application claims the benefit of U.S. provisional patent applications “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, and “Streaming A Segmented Artificial Intelligence Virtual Assistant With Probabilistic Buffering” Ser. No. 63/557,628, filed Feb. 26, 2024.

This application is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video generation and more particularly to synthesized responses to predictive livestream questions.

### BACKGROUND

The world of ecommerce includes strategies designed to bring attention to products and services for sale. Advertising and marketing strategies have been used in nations and cultures across history. In some cultures, town criers were used to inform potential buyers of goods and services for sale. Branding of products and tradesmen was used as long ago as 1,300 BC in India to show customers which artisan or family had crafted pieces of pottery or jewelry. Newspaper advertising appeared in Italy during the 16th century, and the practice soon spread to the rest of Europe. By the 1800s, French newspapers were selling advertising space. Soon, the advertising space paid the entire cost of producing the newspapers. Eventually, it became the primary way in which the newspapers generated profits.

In modern times, entire staff departments are dedicated to the design and management of advertising pieces, and plan strategies to put their messages across to consumers and businesses. Advertising and marketing can use multiple media to reach potential customers. Print advertising is still widely used in newspapers, magazines, mail pieces, posters, billboards, and door hangers. Ad designers use lettering, color, drawings, photographs, and carefully written content to draw the attention of customers and motivate them towards a purchase. Politicians generate letters, flyers, buttons, banners, balloons, hats, and many other forms of advertising to relay their messages and rally support for an important floor vote or the next election. Low flying airplanes tow large signs up and down beaches, often with website addresses or phone numbers to restaurants or other attractions. Electronic media ads are now commonplace. Television, radio, feature films, short films, and livestreams are all used as mediums for advertising and marketing campaigns. Search engines and social networks are paid for primarily by advertising. Search engine companies do in-depth analyses of user search patterns, website selections, and so on to help companies target advertising to customers who are most likely to respond to their offerings.

Ecommerce advertising is not all generated by professional companies or manufacturers. Consumers can discover and be influenced to purchase products or services based on recommendations from friends, peers, and influencers on social networks. This discovery and influence can take place via posts from influencers and tastemakers, as well as friends and other connections within the social media systems. In many cases, influencers are paid for their efforts by website owners or advertising groups. Product experts and amateur users can generate videos demonstrating how to use all sorts of items. Videos of cooking classes, plumbing a bathroom, choosing accessories for a night on the town, planning a vegetable garden, or learning the latest dance moves can all be found on multiple online media sources. Social media and video content platforms are designed to build profiles of users as they select videos and other content. These profiles can be used to select targeted advertising as well as other related content. The profile information can also be sold to other media outlets and advertisers. The drive to promote goods and services, as well as to influence others through education, political speeches, and so on, will only increase as our world continues to grow.

### SUMMARY

Livestream events are a valuable means of engaging viewers in education, government, and ecommerce. As livestream events proliferate, viewers are becoming more discriminating in their choices of event content, delivery, and hosts. Finding the best spokesperson for a livestream event can be a critical component to the success of marketing a product. Ecommerce consumers can discover and be influenced to purchase products or services based on recommendations from friends, peers, and trusted sources (like influencers) on various social networks. This discovery and influence can take place via posts from influencers and tastemakers, as well as friends and other connections within the social media systems. Livestream events can be used to combine prerecorded, designed content with viewers and hosts. These collaborative events can be used to promote products and gather comments and opinions from viewers at the same time. Operators, whether human or machine learning AI models behind the scenes, can respond to viewers in real time, engaging the viewers and increasing the sales opportunities. By harnessing the power of machine learning and artificial intelligence (AI), media assets can be used to inform and promote products using the images and voices of influencers best suited to the viewing audience. Using the techniques of disclosed embodiments, it is possible to create effective and engaging content in real time collaborative events.

Disclosed embodiments provide techniques for synthesized responses to predictive livestream questions. A livestream featuring a host is accessed and is viewed by one or more viewers. The audio, video, and images from the livestream are analyzed and a plurality of potential questions from the one or viewers is predicted based on the analysis. An answer to each potential question is generated based on a large language model (LLM) neural network. A synthesized video segment is created for each answer generated by a generative AI chatbot linked to a LLM for each potential question. During the livestream, real-time questions from the one or more viewers are detected. The real-time questions are matched to the synthesized video segment answers and the matched synthesized video segment is rendered to the one or more livestream viewers. An ecommerce environment is rendered during the livestream to allow purchasing of products.

A computer-implemented method for video generation is disclosed comprising: accessing a livestream, wherein the livestream features a host and is viewed by one or more viewers; analyzing audio from the livestream; predicting a plurality of potential questions from the one or more viewers, wherein the predicting is based on the audio that was analyzed; generating an answer to each potential question within the plurality of potential questions, wherein the generating is based on a large language model (LLM) neural network; creating a synthesized video segment for each answer to each potential question within the plurality of potential questions, wherein the synthesized video segment is associated with the potential question that was answered; storing the video segment associated with each potential question from the plurality of potential questions; detecting a real-time question from the one of more viewers within the livestream; matching the real-time question with a synthesized video segment that was stored, wherein the matching is based on the potential question that was associated with the synthesized video segment; and rendering the synthesized video segment that was matched to the one or more viewers. In embodiments, the analyzing includes analyzing one or more images from the livestream. Some embodiments comprise recognizing when the host views a product for sale. Some embodiments comprise recognizing when the host demonstrates a product for sale. In embodiments, the one or more images include images of the one or more viewers. Some embodiments comprise identifying a confused look from the one or more viewers.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for synthesized responses to predictive livestream questions.

FIG. 2 is an infographic for synthesized responses to predictive livestream questions.

FIG. 3 is an infographic for a livestream with a synthetic scene insertion based on viewer interaction.

FIG. 4 is an example for determining a response to an interaction.

FIG. 5 is an infographic for analyzing a livestream.

FIG. 6 illustrates an ecommerce purchase.

FIG. 7 is a system diagram for synthesized responses to predictive livestream questions.

### DETAILED DESCRIPTION

Consumers and business buyers alike continue to seek out interactions with knowledgeable salespeople, influencers, or product experts as they consider what products and services to buy. Students prefer classes in which they can interact with fellow students and educators. Seminars in which the attendees can ask questions and make comments about the subject matter and relate to the host and other attendees are highly valued, even in our modern, electronic age. The preference to interact in real time with others and to get immediate answers to questions continues to challenge ecommerce merchants, educators, governments, and local tradespeople. Providing answers to questions and responding to comments in real time during livestream events, whether for sales, education, political campaigning, or demonstrations, can lead to better viewer engagement, higher sales, and more productive social interactions.

Disclosed embodiments address the ability to respond to viewer questions and comments in real time during livestream events. A livestream event featuring a host and viewers can be accessed and analyzed in real time. Both audio and video images can be captured and analyzed by natural language processing models and AI (artificial intelligence) machine learning models in order to identify subjects, products, people, events, and ideas that may generate questions from viewers as the livestream progresses. These potential questions can be captured and fed to a large language model (LLM) that can respond with answers in common human language. The interaction with the LLM can be implemented through a generative AI chatbot which can take in questions in many different forms and respond, with answers assembled from thousands of different sources, in humanlike language. These responses can become the basis for a library of synthesized video segments, featuring the livestream host, an assistant, or even an animated character, depending on the viewer audience. As the livestream progresses and viewers generate questions and comments, the questions can be captured and matched to one of the synthesized video segments. The selected video segment can then be inserted seamlessly into the livestream, so that the viewer simply sees a real-time response to their question or comment as the livestream continues. In ecommerce livestreams, an ecommerce environment can be rendered to the viewer along with the livestream videos, so that real-time purchases can be made without interrupting the flow of the livestream event.

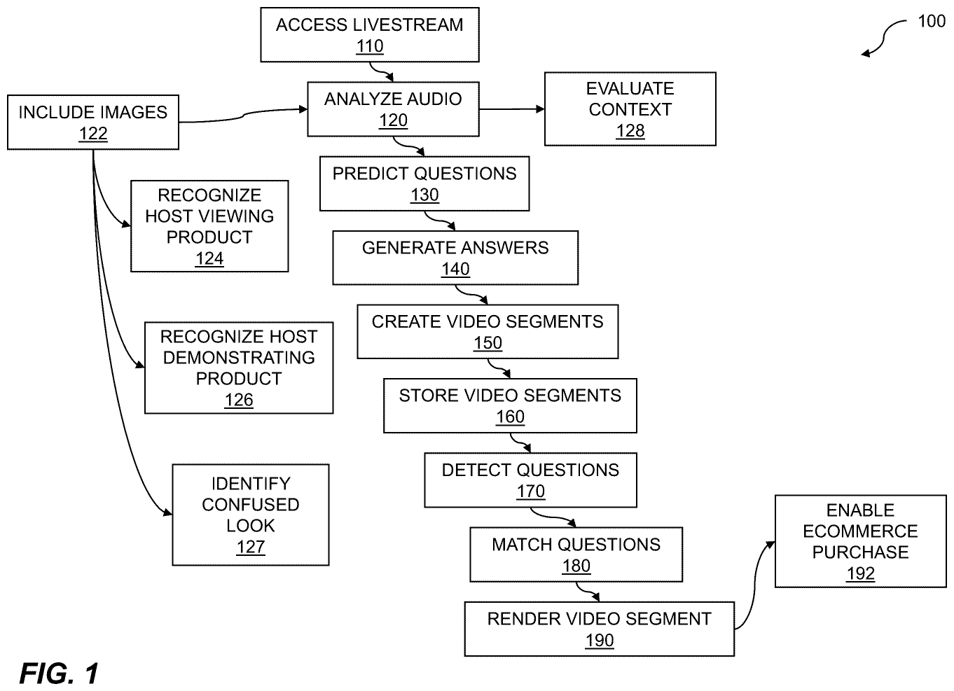

FIG. 1 is a flow diagram 100 for synthesized responses to predictive livestream questions. The flow 100 includes accessing a livestream 110, wherein the livestream features a host and is viewed by one or more viewers. In embodiments, the livestream can be hosted by an ecommerce website, a social media network site, etc. The accessing includes all images, videos, audio, text, chats, interactions, emojis, media, and products for sale contained in the livestream or in the exchange that occurs adjacent to the livestream.

The flow 100 includes analyzing audio 120 from the livestream. In embodiments, the analyzing includes audio and text viewer interactions between viewers, the livestream host, and an assistant. The viewer interactions can include questions, responses, or comments that occur during the livestream event. The analyzing includes natural language processing (NLP). NLP is a category of artificial intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm; language generation; and language interaction, including dialogue systems, voice assistants, and chatbots. In embodiments, the livestream audio analyzing includes NLP to evaluate and understand the text and the context of voice and text communication during the livestream. NLP can be used to detect one or more topics discussed by the livestream host and viewers. Thus, in embodiments, the analyzing audio further comprises detecting a topic being discussed by the host. The flow 100 includes evaluating a context 128 of the livestream. In embodiments, the context includes a topic of discussion in the livestream. In other embodiments, the context includes other livestreams. The context can include products for sale, brands, topics discussed in the livestream, and so on. The evaluating a context can include determining a topic of discussion during the livestream; understanding references to and information from other livestreams; evaluating products for sale or product brands; and recognizing livestream hosts associated with a brand, product for sale, or topic.

The flow 100 includes analyzing one or more images 122 from the livestream, including video images, images of products for sale, and so on. In embodiments, the one or more images include images of the host. In other embodiments, the one or more images comprise a video. The analyzing includes recognizing when a host views or highlights a product for sale 124. In further embodiments, the analyzing includes recognizing when a host demonstrates a product for sale 126. The analyzing can include images of one or more viewers. Additionally, the analyzing can include identifying a confused look 127 from one or more viewers. Thus, the identifying can help to determine when a synthetic video segment is needed to clarify a topic or give more information about a product for sale. Identifying confusion can also be used in determining the quality of the matching of a synthetic video segment to a viewer question or host comment. For example, in an education livestream, identifying confusion in the faces or postures of one or more students can be used to help a livestream teacher host determine which topics to cover more thoroughly during the livestream or subject matters to include in subsequent testing.

In embodiments, the livestream audio analyzing, image analyzing, and evaluating context can all be used to identify discussion topics, host qualities and interests, products for sale, subject matter, and so on, that can generate questions to be answered by the livestream host or assistant. The potential questions can be identified by direct questions asked by livestream participants; comments made in livestream chats or verbal exchanges; demonstrations, looks, or gestures made by the livestream host; and so on. The analyzing of audio and images can be accomplished in real time and can encompass all forms of media content contained in the livestream from the start of the event. In embodiments, the analyzing includes analysis of images, videos, audio, text, chats, interactions, emojis, media, and products for sale contained in the livestream or exchange that occurs adjacent to the livestream. The analyzing can include analysis of questions asked so far in the livestream. As the analyzing occurs, items, subjects, and topics of discussion are identified and used to predict potential questions 130 that can be generated by viewers.

The flow 100 includes predicting a plurality of potential questions 130 from the one or more viewers, wherein the predicting is based on the audio that was analyzed. Products for sale can create potential questions about how they can be used, what colors or sizes are available, physical size and weight of products, and so on. Questions about a livestream host can be predicted in relation to topics being discussed during a livestream. These questions can include queries such as, “What are the host's credentials or what experience do they have?” or “How long has it been since the host actually worked in a particular field?” Questions about topics discussed during a livestream can be generated as well. These questions can include asking, “What does ‘all natural’ mean on a box of food?” “How fuel efficient is a particular vehicle?” “How long is the warranty on a new electronic device?” “How many stars are in the Milky Way?” “Is time travel possible?” “How long will this hair color last after I apply it?” and so on. In embodiments, the potential questions can be generated from a database of questions asked during other livestreams or comments made during the livestream, or can be generated by an AI machine learning model.

The flow 100 includes generating an answer 140 to each potential question within the plurality of potential questions, wherein the generating is based on a large language model (LLM) neural network. A large language model is a type of machine learning model that can perform a variety of natural language (NLP) tasks, including generating and classifying text, answering questions in a human conversational manner, and translating text from one language to another. The machine learning model in a LLM neural network can include hundreds of billions of parameters. LLMs are trained with millions of text entries, including entire books, speeches, scripts, and so on. The LLM can include a multimodal model wherein text, audio, one or more images, one or more videos, and the like can be supplied as inputs to the LLM neural network. In embodiments, the generating includes the livestream as an input to the LLM neural network. In a usage example, the large language model (LLM) neural network includes a generative artificial intelligence (AI) chatbot. Generative artificial intelligence (AI) is a type of AI technology that can generate various types of content including text, imagery, audio, and synthetic data. The most recent versions of generative AI use generative adversarial networks (GANs) to create the content. A generative adversarial network uses samples of data, such as sentences and paragraphs of human-written text, as training data for a model. The training data is used to teach the model to recognize patterns and generate new examples based on the patterns. In embodiments, each potential question within the plurality of potential questions can be fed into an LLM/generative AI chatbot and the answer can be captured and used to create a video response to the potential question.

The flow 100 includes creating a synthesized video segment 150 for each answer to each potential question within the plurality of potential questions, wherein the synthesized video segment is matched with the potential question that was answered. In embodiments, each synthesized video segment that was matched comprises a performance by the livestream host. In other embodiments, each synthesized video segment that was matched comprises a performance by an assistant. An image of the livestream host can be captured from the livestream in real time and from other media sources. The media sources can include one or more photographs, videos, livestream events, and livestream replays, including the voice of the livestream host. In some embodiments, a photorealistic representation of the livestream host can include a 360-degree representation. The livestream host can comprise a human host that can be recorded with one or more cameras, including videos and still images, and microphones for voice recording. The recordings can include one or more angles of the human host and can be combined to comprise a dynamic 360-degree photorealistic representation of the human host. The voice of the human host can be recorded and included in the representation of the human host. The images of the livestream host can be isolated and combined in an AI machine learning model to create a 3D model that can be used to generate a video segment in which the synthesized livestream host responds to the potential questions using the answers generated by the LLM/generative AI chatbot. The voice used by the livestream host can be synthesized from voice samples captured from the livestream and other audio sources. In embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. In some embodiments, a 3D model of the livestream host or assistant can be used as the performer of animation generated by a game engine, after the sequence of movements and dialogues have been decided. The result is a synthesized performance by the livestream host model, combining animation generated by a game engine and the 3D model of the individual, including the voice of the individual. In some embodiments, the livestream host or assistant can be a representation of another individual or an animated character. After the synthesized video segment has been created, it can be stored 160 in a library of short-form videos for use in responding to real-time questions during the livestream. The synthesized video segment can use metadata that includes the related topic, subject matter, product, historical timeframe, region, names of related parties, and so on. The metadata can be used in later steps to match the synthesized video segment to a comment or question made by a viewer during the livestream.

The flow 100 includes detecting a real-time question 170 from the one or more viewers within the livestream. As the livestream progresses, viewers can make comments or ask questions of one another and the livestream host or assistant. The audio from the livestream, and the text of livestream chats, can be analyzed by an AI machine learning model including NLP and can be used to identify questions to be answered by the livestream host or assistant. The detecting can include questions or comments made by the livestream host or assistant as the livestream progresses.

The flow 100 includes matching the real-time question 180 with a synthesized video segment that was stored, wherein the matching is based on the potential question that was associated with the synthesized video segment. In embodiments, the matching is based on a fuzzy matching algorithm working with natural language processing. Fuzzy matching, also called approximate string matching, is a technique that helps to identify elements in strings of text that are similar but not necessarily exactly the same. The comparison of comments or questions captured from a livestream to metadata or text included in the potential question video segments can result in a set of most likely matches to topics or subjects identified in the viewer question or comment. In some embodiments, the matching includes one or more synthesized videos that were generated in response to potential questions associated with a previous livestream or livestream replay.

The flow 100 includes rendering the synthesized video segment 190 that was matched to the one or more viewers. In embodiments, the rendering occurs while the host is displayed in the livestream. The livestream host can be a human or synthesized host. The determining of at least one insertion point for the synthesized video segment is accomplished by analyzing the livestream. The analyzing is done by AI machine learning and can include detecting questions generated by the host or viewer participants in the livestream, or detecting one or more subject matters discussed by the host. The object of the analysis is to identify specific points in the livestream where the synthesized video segment can be added into the real-time replay seamlessly, so that the viewers are unaware of the transition from the livestream replay to the synthesized video. In some embodiments, the determining of the insertion point can form a response to the interaction of viewers of the livestream. As the livestream is played, viewers can ask for more information about a product for sale that is highlighted by the host, can interact on a particular subject being discussed by the host, etc. If a viewer completes a purchase, donates, or signs up for a promotion, the livestream operator can insert a recognition by the host using a synthesized video segment. AI-generated speech can be used to add the username of the viewer as provided in a text interaction during the livestream event, etc. Thus, in some embodiments, answers are rendered in real time or near real time.

In embodiments, inserting the synthesized video segment is accomplished by stitching the synthesized video segment into the prerecorded livestream at the one or more insertion points. Video stitching is the process of combining two or more videos so that they play one after the other without a noticeable transition from one video to the next. For example, a prerecorded livestream can include a series of frames A, B, C, D, and E. A synthesized video segment can include a series of frames L, M, and N. The livestream operator selects frame C as the insertion point for the synthesized video segment. The result of the insertion process is the series of frames A, B, C, L, M, N, D, and E. The stitching occurs at one or more boundary frames at the one or more insertion points, between the synthesized video and the livestream. The stitching process may use copies of frames from other points in the livestream or synthesized video. It may repeat frames within either video or delete frames as needed in order to produce the least noticeable transition from the livestream to the synthesized video.

The flow 100 includes enabling an ecommerce environment. The rendering further comprises enabling an ecommerce purchase 192, within the ecommerce environment, of one or more products for sale. In embodiments, a livestream that highlights products for sale can include an ecommerce environment that enables ecommerce purchases of one or more products for sale. The ecommerce environment can include a virtual purchase cart that can be displayed during the livestream. The virtual purchase cart can be used by one or more viewers during the livestream without interrupting the livestream video. In some embodiments, the ecommerce environment can include an on-screen product card representing one or more products for sale.

In embodiments, the livestream host can highlight products and services for sale during the livestream event. The host can demonstrate, endorse, recommend, and otherwise interact with one or more products for sale. An ecommerce purchase of at least one product for sale can be enabled to the viewer, wherein the ecommerce purchase is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale is revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

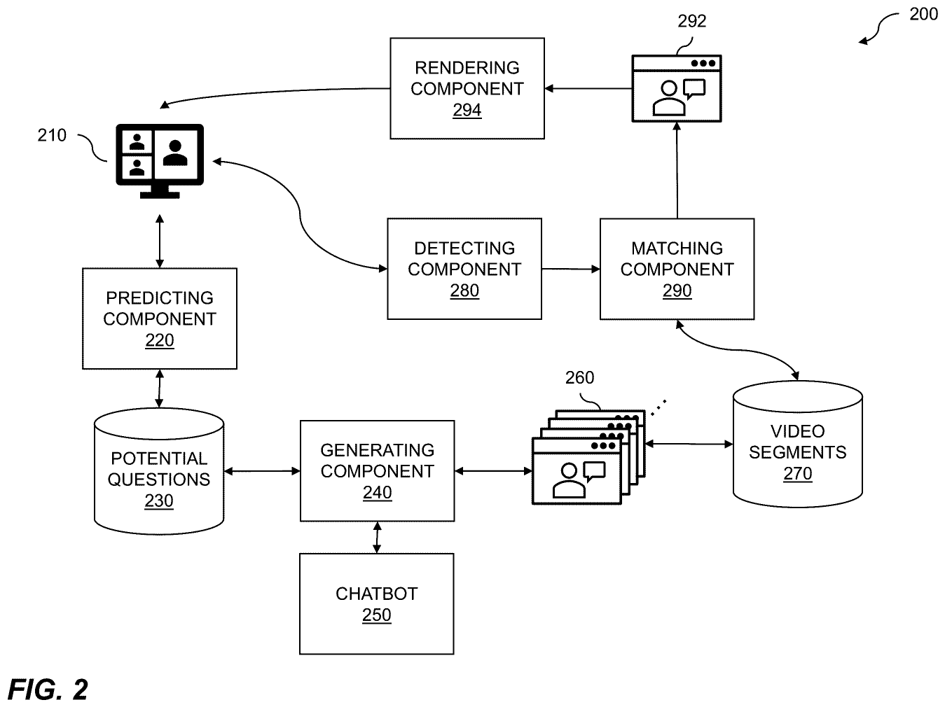

FIG. 2 is an infographic 200 for synthesized responses to predictive livestream questions. The infographic 200 includes accessing a livestream 210, wherein the livestream features a host and is viewed by one or more viewers. In embodiments, the livestream can be hosted by an ecommerce website, a social media network site, etc. The accessing includes all images, videos, audio, text, chats, media, and products for sale contained in the livestream.

The infographic 200 includes a predicting component 220. In embodiments, the images and audio from the livestream can be analyzed to identify discussion topics, host qualities and interests, products for sale, subject matter, and so on, that can generate questions to be answered by the livestream host or assistant. The potential questions 230 can be identified by direct questions asked by livestream participants; comments made in livestream chats or verbal exchanges; demonstrations, looks, or gestures made by the livestream host; and so on. The analyzing of audio and images can be accomplished in real time and can encompass all forms of media content contained in the livestream from the start of the event. As the analyzing occurs, items, subjects, and topics of discussion are identified and used to predict potential questions that can be generated by viewers. Products for sale can create potential questions about how they can be used, what colors or sizes are available, physical size and weight of the products, and so on. Questions about a livestream host can be predicted in relation to topics being discussed during a livestream. These questions can include queries such as, “What are the host's credentials or what experience do they have?” or “How long has it been since the host actually worked in a particular field?” Questions can be generated about topics discussed during a livestream as well. These questions can ask: “What does ‘all natural’ mean on a box of food?” “How fuel efficient is a particular vehicle?” “How long is the warranty on a new electronic device?” “How many stars are in the Milky Way?” “Is time travel possible?” “How long will this hair color last after I apply it?” and so on. In embodiments, the potential questions can be generated from a database of questions asked during other livestreams or comments made during the livestream, or can be generated by an AI machine learning model.

The infographic 200 includes a generating component 240. The generating component is used to generate an answer to each potential question 230 within the plurality of potential questions, wherein the generating is based on a large language model (LLM) neural network. A large language model is a type of machine learning model that can perform a variety of natural language (NLP) tasks, including generating and classifying text, answering questions in a human conversational manner, and translating text from one language to another. The machine learning model in a LLM neural network can include hundreds of billions of parameters. LLMs are trained with millions of text entries, including entire books, speeches, scripts, and so on. In some embodiments, the LLM is associated with a generative Artificial Intelligence (AI) chatbot. Generative artificial intelligence (AI) is a type of AI technology that can generate various types of content including text, imagery, audio, and synthetic data. The most recent versions of generative AI use generative adversarial networks (GANs) to create the content. A generative adversarial network uses samples of data, such as sentences and paragraphs of human-written text, as training data for a model. The training data is used to teach the model to recognize patterns and generate new examples based on the patterns. In embodiments, each potential question within the plurality of potential questions can be fed into an LLM/Generative AI chatbot 250 and the answer can be captured and used to create a video response to the potential question.

The infographic 200 includes creating a synthesized video segment 260 and storing a synthesized video segment 270 for each generated answer to each potential question within the plurality of potential questions, wherein the synthesized video segment is matched with the potential question that was answered. In embodiments, each synthesized video segment that was matched comprises a performance by the livestream host. In other embodiments, each synthesized video segment that was matched comprises a performance by an assistant. In further embodiments, the assistant is the host. An image of the livestream host can be captured from the livestream in real time and from other sources. The media sources can include one or more photographs, videos, livestream events, and livestream replays, including the voice of the livestream host. In some embodiments, a photorealistic representation of the livestream host can include a 360-degree representation. The livestream host can comprise a human host that can be recorded with one or more cameras, including videos and still images, and microphones for voice recording. The recordings can include one or more angles of the human host and can be combined to comprise a dynamic 360-degree photorealistic representation of the human host. The voice of the human host can be recorded and included in the representation of the human host. The images of the livestream host can be isolated and combined in an AI machine learning model into a 3D model that can be used to generate a video segment in which the synthesized livestream host responds to the potential questions using the answers generated by the LLM/generative AI chatbot. The voice used by the livestream host can be synthesized from voice samples captured from the livestream and other audio sources. In embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. In some embodiments, a 3D model of the livestream host or assistant can be used as the performer of animation generated by a game engine, after the sequence of movements and dialogues have been decided. The result is a synthesized performance by the livestream host model, combining animation generated by a game engine and the 3D model of the individual, including the voice of the individual. In some embodiments, the livestream host or assistant can be a representation of another individual or an animated character. After the synthesized video segment has been created, it can be stored in a library of short-form videos for use in responding to real-time questions during the livestream.

The infographic 200 includes a detecting component 280. As the livestream 210 progresses, viewers can make comments or ask questions of one another and the livestream host or assistant. The audio from the livestream, and the text of livestream chats, can be analyzed by an AI machine learning model including NLP and can be used to identify questions to be answered by the livestream host or assistant. The detecting can include questions or comments made by the livestream host or assistant as the livestream progresses.

The infographic 200 includes matching 290 a real-time question 292 with a synthesized video segment that was stored, wherein the matching is based on the potential question that was associated with the synthesized video segment. In embodiments, the matching is based on a fuzzy matching algorithm working with natural language processing. Fuzzy matching, also called approximate string matching, is a technique that helps to identify elements in strings of text that are similar but not necessarily exactly the same. The comparison of comments or questions captured from a livestream to metadata or text included in the potential question video segments can result in a set of most likely matches to topics or subjects identified in the viewer question or comment. In some embodiments, the matching can include one or more synthesized videos that were generated in response to potential questions associated with a previous livestream or livestream replay.

The infographic 200 includes a rendering component 294. In embodiments, the rendering can occur while the host is displayed in the livestream. The livestream host can be a human or synthesized host. The determining of at least one insertion point for the synthesized video segment is accomplished by analyzing the livestream. The analyzing is done by AI machine learning and can include detecting questions generated by the host or viewer participants in the livestream or detecting one or more subject matters discussed by the host. The object of the analysis is to identify specific points in the livestream where the synthesized video segment can be added into the real-time replay seamlessly, so that the viewers are unaware of the transition from the livestream replay to the synthesized video. In some embodiments, the determining of the insertion point can form a response to the interaction of viewers of the livestream. As the livestream is played, viewers can ask for more information about a product for sale that is highlighted by the host, can interact on a particular subject being discussed by the host, etc. If a viewer completes a purchase, donates, or signs up for a promotion, the livestream operator can insert a recognition by the host using a synthesized video segment. AI-generated speech can be used to add the username of the viewer as provided in a text interaction during the livestream event, etc. Inserting the synthesized video segment is accomplished by stitching the synthesized video segment into the prerecorded livestream at the one or more insertion points. Video stitching is the process of combining two or more videos so that they play one after the other without a noticeable transition from one video to the next.

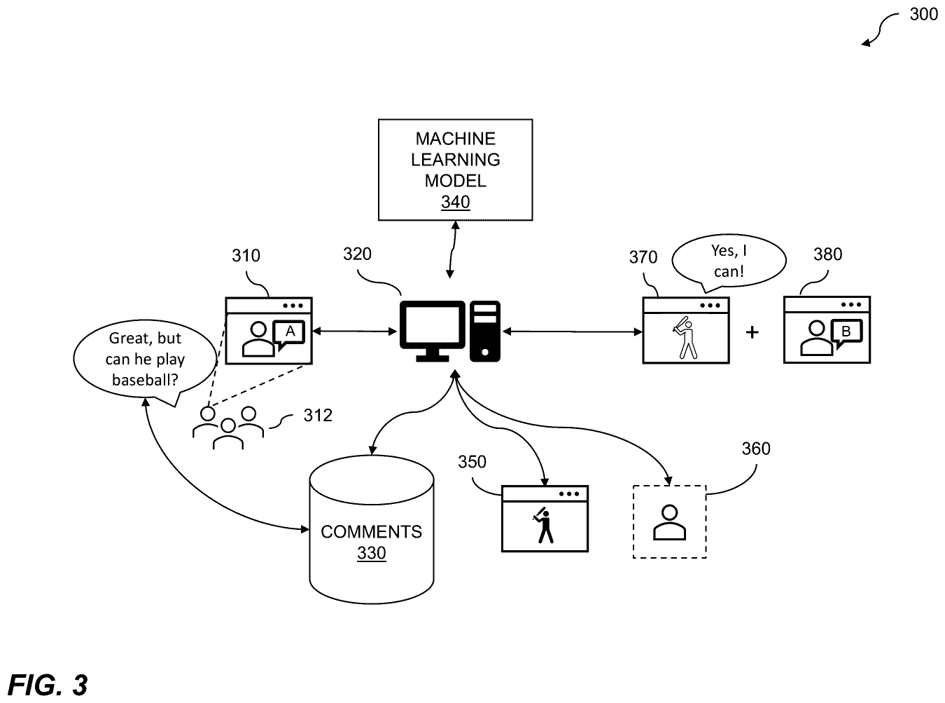

FIG. 3 is an infographic 300 for a livestream with a synthetic scene insertion based on viewer interaction. A livestream can be accessed and presented to a group of viewers. The livestream can be accessed by viewers in real time, allowing interaction between viewers, hosts, and operators of the livestream. Synthesized video segments related to questions posed by viewers during the livestream can be matched to respond to viewer questions and can then be rendered to the livestream event. The synthesized video segments can be selected based on comments or questions raised by viewers during the livestream event. The individual performing in the video segments can be a different presenter from the host of the livestream. In some embodiments, images of the livestream host can be collected and combined using artificial intelligence (AI) machine learning to create a 3D model of the host, including facial features, expressions, gestures, clothing, accessories, etc. The 3D model of the host can be combined with the video segments to create synthesized video segments in which the livestream host is seen as the presenter. AI machine learning can be used to swap the voice of the video segment individual presenter with the voice of the livestream host. Thus, the host of the livestream becomes the presenter of the synthesized video segments for the viewers.

The livestream can be analyzed to determine insertion points for the synthesized video segments into the livestream event. The livestream operator can select the insertion point based on the comments and questions raised by viewers during the livestream event, so that the synthesized video segment becomes the response to the viewer comment or question. The insertion of the synthesized video segment can be accomplished dynamically and can appear seamless to the viewer. The insertion of the synthesized video segment can be accomplished by stitching the segment into the livestream event at one of the determined insertion points. One or more boundary frames can be identified in the livestream and the synthesized video segment and can be used to smooth the transition from the livestream to the video segment. At the end of the synthesized video segment, boundary frames can be used to smooth the transition back to the remainder of the livestream.

The infographic 300 includes viewers 312 watching a livestream 310. A livestream is a streaming media event that is simultaneously recorded and broadcast in real time over the Internet. It can include audio, video, or both at the same time. Livestreaming can include a wide variety of topics, including sporting events, video games, artistic performances, marketing campaigns, political speeches, advertising presentations, and so on. Once recorded, the livestream event can be replayed and expanded upon as viewers comment and interact with the replay of the livestream event in real time.

The infographic 300 includes an operator 320 that can monitor the livestream event as viewers 312 watch and interact with the livestream 310. In embodiments, the operator can listen to verbal comments made by viewers, see comments and questions made by viewers in a chat associated with the livestream, and so on. In some embodiments, the verbal questions and comments made by viewers can be analyzed by an AI machine learning model. The operator 320 can access an artificial intelligence (AI) machine learning model 340 and a library of stored short-form video segments 350. The stored video segments can contain responses to viewer questions generated by a generative AI chatbot. The operator can use the video segments to respond to the comments of viewers as the livestream is rendered. For example, the comment, “Great, but can he play baseball?” can be made by a viewer 312 as the livestream 310 is rendered for the viewers 312. The comment can be recorded and accessed by the livestream operator. The livestream operator can access a library of related video segments and select a video segment that includes an individual playing baseball.

The infographic 300 includes one or more images of the livestream host 360. In embodiments, one or more images of the host 360 can be retrieved from the video and from other sources, including short-form videos and still photographs. Using a machine learning artificial intelligence (AI) neural network, the images of the host can be used to create a 3D model of the host, including facial expressions, gestures, articles of clothing, accessories, and so on. The various components of the 3D model can be isolated and swapped out as desired, so that a product for sale or alternate article of clothing can be included in a synthesized video using the 3D model. As discussed above and throughout, 3D model of the host can be built using a generative model. The generative model can include a generative adversarial network (GAN). Using the GAN, the images of the livestream host 360 can be combined with the video segment 350 to create a synthesized video segment 370 in which the livestream host renders the performance of the individual in the video segment 350.

The infographic 300 includes the operator 320 using an AI machine learning model 340 to dynamically insert a synthesized video segment 370 into the livestream 310. In embodiments, the inserting of the synthesized video segment 370 forms a response to comments 330 made by viewers 312 as the livestream 310 is rendered. For example, the synthesized video segment that combines the images of the host with the individual playing baseball can be dynamically inserted by the livestream operator. The synthesized video segment 370 forms a response to the viewer question, “Great, but can he play baseball?” An AI-generated voice response, “Yes, I can!”, using the voice of the livestream host, can be added to the synthesized video segment 370 by the livestream operator to further enhance the experience of the viewers 312 as the video segment 370 is rendered. In some embodiments, the response contained in the synthesized video segment 370 is based on an answer generated by a generative AI chatbot.

The infographic 300 includes rendering the remainder of the livestream 380 after the synthesized video segment 370 insertion. As discussed above and throughout, a stitching process can be used to create a seamless transition from the livestream 310 to the synthesized video segment 370. A similar stitching process can be used to create a seamless transition from the end of the synthesized video segment 370 to the remainder of the livestream 380. The stitching occurs at one or more boundary frames at the insertion point between the synthesized video segment 370 and the remainder of the livestream 380. The stitching process may use copies of frames from other points in the livestream 310 or the synthesized video segment 370. It may repeat frames within either video or delete frames as needed in order to produce the least noticeable transition from the livestream to the synthesized video. Thus, the viewers 312 are dynamically engaged as the livestream operator 320 uses synthesized video segments 370 to respond directly to viewer comments 330 as they occur in real time during replay of the livestream 310.

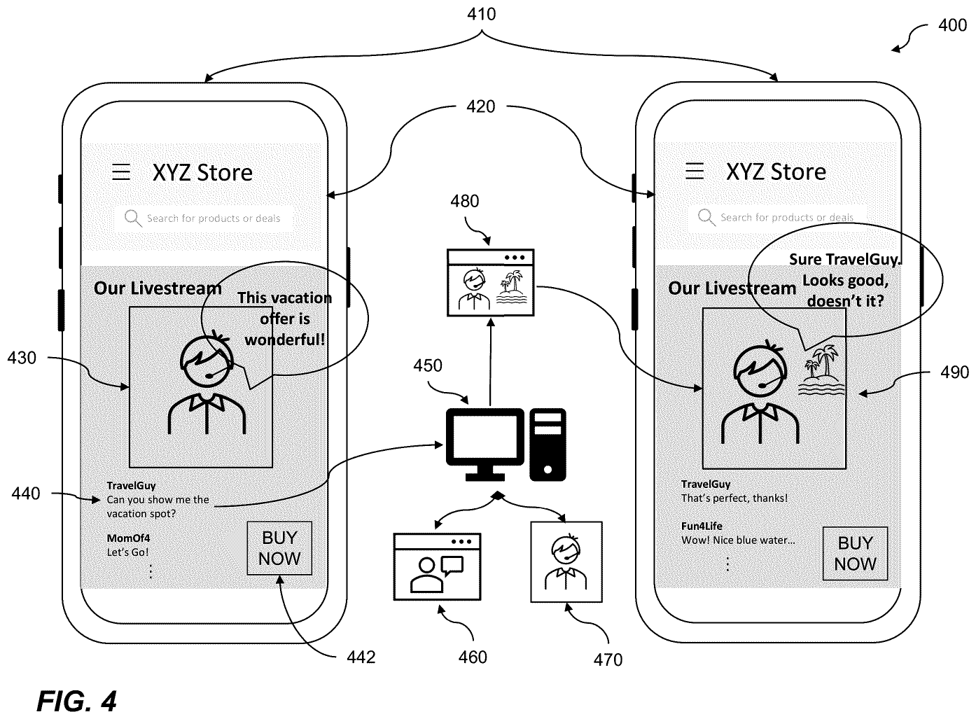

FIG. 4 is an example 400 for determining a response to an interaction. A livestream event can be accessed and presented to a group of viewers. The viewers can watch the livestream on connected television (CTV) devices including smart TVs with built-in internet connectivity, televisions connected to the Internet via set-top boxes, TV sticks, and so on. The livestream can be accessed by viewers in real time, allowing participation and interaction between viewers, hosts, and operators of the livestream. Short-form video segments related to products and subjects discussed during the livestream can be accessed by the operator of the livestream. The video segments can be based on potential questions predicted by an AI machine learning model. The AI machine learning model can analyze the audio and video of the livestream as it plays and predict a plurality of potential questions about highlighted products for sale or other comments made by the livestream host and viewers. The potential questions can be fed to a generative AI chatbot. Synthetic host video segments can be generated based on the answers given by the generative AI chatbot and can be stored for use as the livestream progresses. The individual performing in the video segments can be a different presenter from the host of the livestream. Images of the livestream host can be collected and combined using artificial intelligence (AI) machine learning to create a 3D model of the host, including facial features, expressions, gestures, clothing, accessories, etc. The 3D model of the host can be combined with the video segments to create synthesized video segments in which the livestream host is seen as the presenter. AI machine learning can be used to swap the voice of the video segment individual presenter with the voice of the livestream host. Thus, the host of the livestream becomes the presenter of the synthesized video segments for the viewers. The synthesized video segments and the livestream can highlight products for sale during a livestream event.

The flow 400 includes a CTV device 410 that can be used to participate in a livestream event 420. A connected television (CTV) is any television set connected to the Internet, including smart TVs with built-in internet connectivity, televisions connected to the Internet via set-top boxes, TV sticks, and gaming consoles. Connected TV can also include Over-the-Top (OTT) video devices or services accessed by a laptop, desktop, pad, or mobile phone. Content for television can be accessed directly from the Internet without using a cable or satellite set-top box.

The flow 400 includes a livestream 420. A livestream is a streaming media event that is simultaneously recorded and broadcast in real time over the Internet. It can include audio, video, or both at the same time. Once recorded, the livestream event can be replayed and expanded upon as viewers comment and interact with the replay of the livestream event in real time. In embodiments, viewers can participate in the livestream event 420 by accessing a website made available by the livestream host using a CTV device such as a mobile phone, tablet, pad, laptop computer, or desktop computer. Participants in a livestream event can take part in chats 440, respond to polls, ask questions, make comments, and purchase products 442 for sale that are highlighted during the livestream event.

The flow 400 includes an operator 450 that can monitor the livestream event 420 as viewers watch and interact with the livestream. In embodiments, the operator 450 can be a human operator or an AI machine learning model. The operator 450 can see comments and questions made by viewers in a chat 440 associated with the livestream. The operator 450 can access an artificial intelligence (AI) machine learning model and a library of related video segments 460. The operator can use the related video segments 460 to respond to the chat comments 440 of viewers as the livestream 420 is rendered. The answer to viewer questions can be based on response generated by a generative AI chatbot. For example, a request, “Can you show me the vacation spot?” can be made by a viewer in a livestream chat 440 as the livestream 420 is rendered for the viewers. The livestream operator can access a library of related video segments 460 and select a video segment that gives more details about the vacation spot and in some embodiments can include images and short-form videos of the vacation spot.

The flow 400 includes replacing the performance of the individual presenter in the video segment 460 with the livestream host 470. In embodiments, one or more images of the livestream host 470 can be retrieved from the livestream and from other sources, including short-form videos and still photographs. Using a machine learning artificial intelligence (AI) neural network, the images of the host 470 can be used to create a 3D model of the host, including facial expressions, gestures, articles of clothing, accessories, and so on. The various components of the 3D model can be isolated and swapped out as desired, so that a product for sale or alternate article of clothing can be included in a synthesized video using the 3D model. As discussed above and throughout, the 3D model of the host can be built using a generative model. The generative model can include a generative adversarial network (GAN). Using the GAN, the images of the livestream host 470 can be combined with the video segment 460 to create a synthesized video segment 480 in which the livestream host renders the performance of the individual in the video segment 460.

The flow 400 includes inserting a synthesized video segment 480 into the livestream. The dynamic inserting of the synthesized video segment 480 can be a response to viewer interactions that occur during the livestream event. The viewer interaction can be detected by an AI machine learning model or a human operator. The inserting can be done dynamically through the use of a human operator 450 or an AI machine learning model operator. In some embodiments, the viewer interactions can be accomplished using polls, surveys, questions and answers, and so on. The responses to viewer comments can be based on products for sale which are highlighted during the livestream performance. The AI machine learning model can analyze the livestream host comments about the products for sale and can prepare synthetic video segments based on a generative AI chatbot response to predicted questions about the highlighted products. For example, in the FIG. 4 infographic, the livestream host 430 says, “This vacation offer is wonderful!” A participant in the livestream responds by asking, “Can you show me the vacation spot?” The operator can dynamically respond to the participant's question by obtaining a prepared video segment that can include an image or short-form video of the product for sale, in this case, the vacation spot. The operator can combine the image of the livestream host with the video segment so that the livestream host can be seen rendering the performance of the individual in the video segment. The operator can insert the synthesized video segment into the livestream seamlessly using one or more insertion points determined by the AI machine learning model. The synthesized video segment 490 becomes the response to the question the viewer generated as part of the livestream event. The operator 450 can use an AI machine learning model to reply to the viewer using the livestream host's voice with the comment, “Sure TravelGuy. Looks good, doesn't it?” In some embodiments, the phrase “Sure . . . Looks good, doesn't it?” can be a pre-recorded video comment so that the username “TravelGuy” is the only portion of the response that is added dynamically during the livestream event by the operator 450.

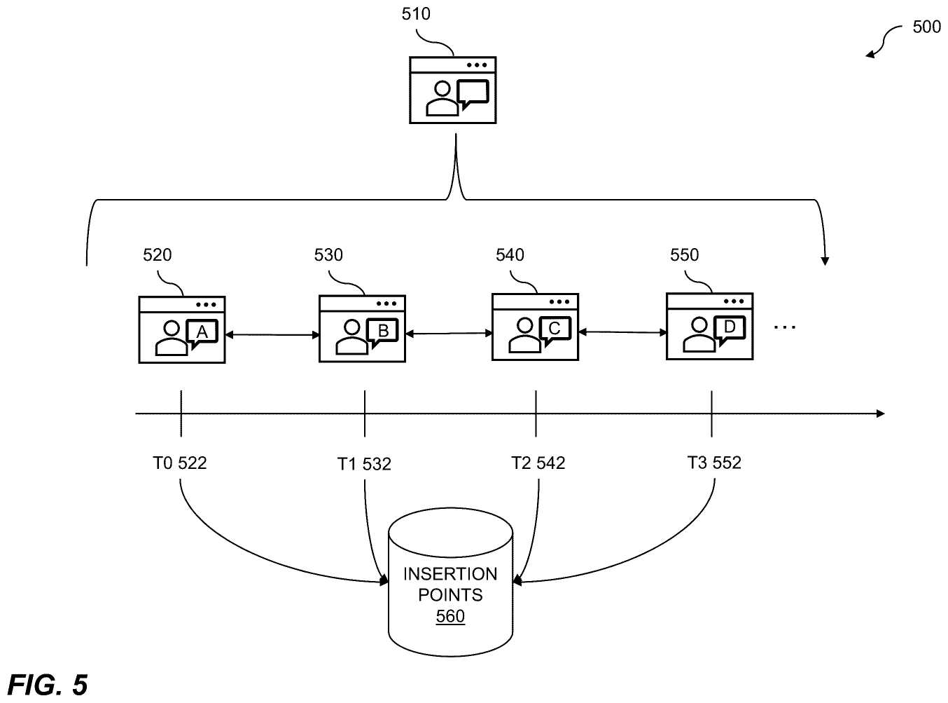

FIG. 5 is an infographic for analyzing a livestream. A livestream event can be accessed and presented to a group of viewers. The replay of the livestream can be accessed by viewers in real time, allowing participation and interaction between viewers and operators of the livestream. Short-form video segments related to products and subjects discussed during the livestream can be accessed by the operator of the livestream. The video segments can be selected based on comments or questions raised by viewers during the livestream event in addition to segments preselected based on subjects and products discussed in the livestream. A livestream operator can use an AI machine learning model to replace the performance of an individual in the video segments with the face, features, and voice of the livestream host. The livestream can be analyzed to determine insertion points for the synthesized video segments into the livestream event. The livestream operator can select the insertion point based on the comments and questions raised by viewers during the livestream event, so that the synthesized video segment becomes the response to the viewer comment or question. The insertion of the synthesized video segment can be accomplished dynamically to appear seamless to the viewer. The insertion of the synthesized video segment can be accomplished by stitching the segment into the livestream event at one of the determined insertion points. One or more boundary frames can be identified in the livestream and the synthesized video segment and can be used to smooth the transition from the livestream to the video segment. At the end of the synthesized video segment, boundary frames can be used to smooth the transition back to the remainder of the livestream.

The infographic 500 includes a livestream 510. A livestream is a streaming media event that is simultaneously recorded and broadcast in real time over the Internet. It can include audio, video, or both at the same time. Livestreaming can include a wide variety of topics, including sporting events, video games, artistic performances, marketing campaigns, political speeches, advertising presentations, and so on. Once recorded, the livestream event can be replayed and expanded as viewers comment on and interact with the replay of the livestream event in real time. In some embodiments, the livestream can be produced from a synthesized short-form video that can include a synthesized version of a host.

The infographic 500 includes a livestream operator analyzing a livestream 510 to determine one or more insertion points 560 for one or more synthesized video segments. In embodiments, the analyzing can include detecting one or more words spoken by the host, one or more actions of the host, one or more voice inflections of the host, or one or more subject matters discussed by the host; assessing the body position of the host; and so on. As in other forms of media editing, the determining of insertion points can be based on replicating what a viewer in a theater, attending a movie, or watching television does naturally by focusing on the most important actors and actions in view. The closer the insertion point matches the exact moment when a viewer expects to see or hear an answer to a question or a response to a comment, to see a product in use, or to view a closeup of the host's face, etc., the more invisible the transition from the livestream to the inserted video segment will be. Another element of determining the insertion point is making sure that the tone values and scene arrangement of the last frame of the livestream match, as nearly as possible, the tone values and scene arrangement of the first frame of the inserted video segment. For example, the transition to a synthesized video segment can include a view of a product for sale in the first few frames of the video segment, followed by a view of the host performing the remainder of the video segment in the same setting as that of the livestream. Today's media viewers are accustomed to a still view of a product lasting two to three seconds as a host voice speaks about the product in commercial advertising, livestream events, and in-home shopping network segments. Selecting a point in a livestream where the host begins to speak about a product for sale can provide a likely spot for inserting a synthesized video segment with more information about the product. After the still view of the product is complete, the synthesized video segment can continue with a view of the host in the same setting as before the insertion of the video segment. The viewer continues to watch the synthesized video segment without noticing the transition from the livestream to the video segment.

The analyzing of the livestream 510 to determine insertion points 560 can be accomplished by an artificial intelligence (AI) machine learning neural network. In some embodiments, the insertion points can be located in the livestream using a generative model. The generative model can include a generative adversarial network (GAN). A generative adversarial network (GAN) includes two parts. A generator learns to generate plausible insertion points in a livestream. The generated instances are input to a discriminator. The discriminator learns to distinguish the generator's fake data from real data. The real data can come from a set of video segment insertions completed by a professional editor. The data can include the actions and body position of the host in the video frames just prior to the insertion point; the text, subject matter, and vocal inflections of the host's voice just prior to the insertion point; and so on. The discriminator penalizes the generator for generating implausible results. During the training process, over time, the output of the generator improves, and the discriminator has less success distinguishing real output from fake output. The generator and discriminator can be implemented as neural networks, with the output of the generator connected to the input of the discriminator. Embodiments may utilize backpropagation to create a signal that the generator neural network uses to update its weights.

The discriminator may use training data coming from two sources, real data, which can include insertion points in the livestream selected by one or more professional editors, and fake data, which includes insertion points identified by the generator. The discriminator uses the fake data as negative examples during the training process. A discriminator loss function is used to update weights via backpropagation for discriminator loss when it misidentifies an insertion point. The generator learns to create fake data by incorporating feedback from the discriminator. Essentially, the generator learns how to “trick” the discriminator into classifying its output as real. A generator loss function is used to penalize the generator for failing to trick the discriminator. Thus, in embodiments, the generative adversarial network (GAN) includes two separately trained networks. The discriminator neural network can be trained first, followed by training the generative neural network, until a desired level of convergence is achieved. In embodiments, livestream and synthesized video segment analyses may be used to generate a set of acceptable insertion points. In FIG. 5, four insertion points are identified: T0 522, T1 532, T2 542, and T3 552. The insertion points correspond to four frames in the livestream (520, 530, 540, and 550) that are identified by the livestream operator and AI machine learning model. In embodiments, the at least one insertion point can be stored with metadata associated with the livestream.

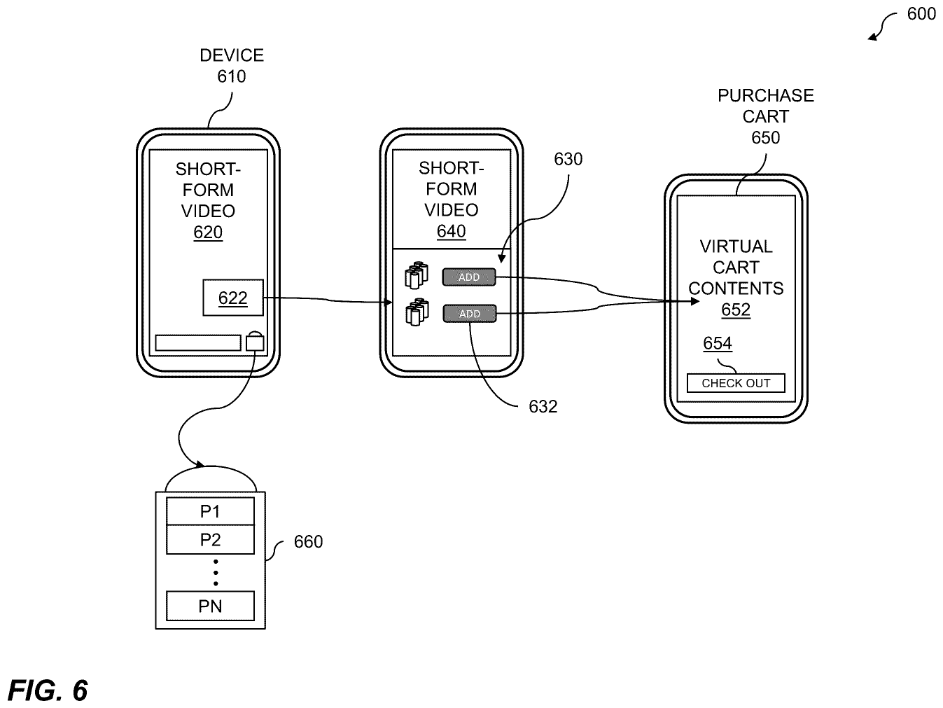

FIG. 6 illustrates an example ecommerce purchase. As described above and throughout, a short-form livestream video can be rendered to one or more viewers. The livestream can highlight one or more products available for purchase during the livestream event. An ecommerce purchase can be enabled during the livestream event using an in-frame shopping environment. The in-frame shopping environment can allow internet connected television (CTV) viewers and participants of the livestream event to buy products and services during the livestream event. The livestream event can include an on-screen product card that can be viewed on a CTV device and a mobile device. The in-frame shopping environment or window can also include a virtual purchase cart that can be used by viewers as the short-form video livestream event plays.

The illustration 600 includes a device 610 displaying a short-form video 620 as part of a livestream event. In embodiments, the livestream can be viewed in real time or replayed at a later time. The device 610 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream on the device can be accomplished using a browser or another application running on the device.

The illustration 600 includes generating and revealing a product card 622 on the device 610. In embodiments, the product card represents at least one product available for purchase while the livestream short-form video plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card 622 can be inserted when the livestream is visible in the livestream event window 640. When the product card is invoked, an in-frame shopping environment 630 is rendered over a portion of the video while the video continues to play. This rendering enables an ecommerce purchase 632 by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 600 includes rendering an in-frame shopping environment 630 enabling a purchase of the at least one product for sale by the viewer, wherein the ecommerce purchase is accomplished within the livestream event window. In embodiments, the livestream event can include the livestream or a prerecorded video segment. The enabling can include revealing a virtual purchase cart 650 that supports checkout 654 of virtual cart contents 652, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 660 are purchased via product cards during the livestream event, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

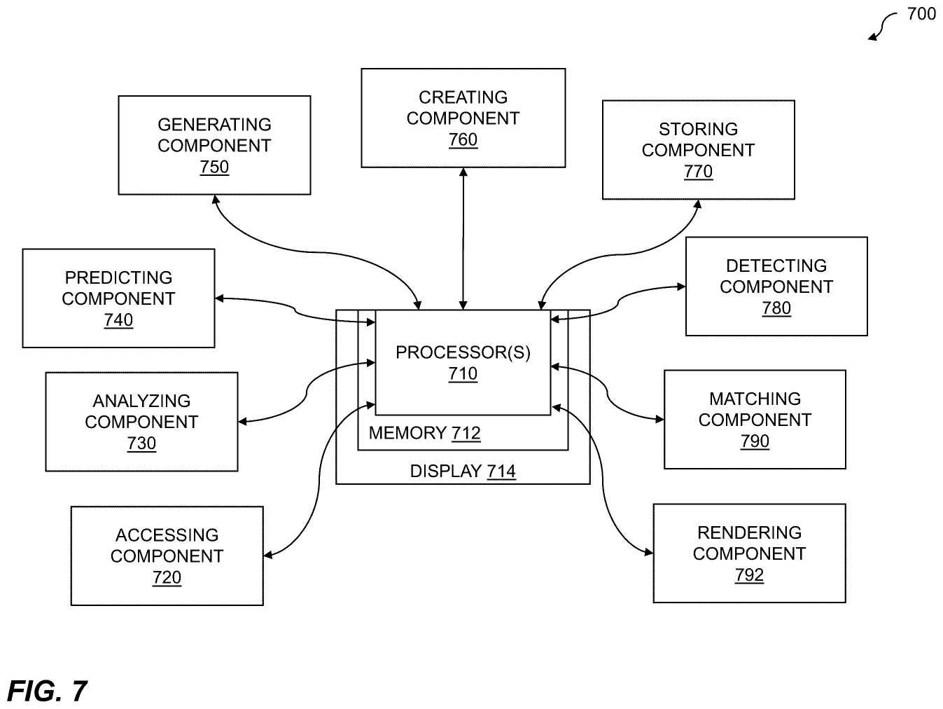

FIG. 7 is a system diagram for synthesized responses to predictive livestream questions. The system 700 can include one or more processors 710 coupled to a memory 712 which stores instructions. The system 700 can include a display 714 coupled to the one or more processors 710 for displaying data, video streams, videos, intermediate steps, instructions, and so on. In embodiments, one or more processors 710 are coupled to the memory 712 where the one or more processors, when executing the instructions which are stored, are configured to: access a livestream, wherein the livestream features a host and is viewed by one or more viewers; analyze audio from the livestream; predict a plurality of potential questions from the one or more viewers, wherein the predicting is based on the audio that was analyzed; generate an answer to each potential question within the plurality of potential questions, wherein the generating is based on a large language model (LLM) neural network; create a synthesized video segment for each answer to each potential question within the plurality of potential questions, wherein the synthesized video segment is associated with the potential question that was answered; store the video segment associated with each potential question from the plurality of potential questions; detect a real-time question from the one of more viewers within the livestream; match the real-time question with a synthesized video segment that was stored, wherein the matching is based on the potential question that was associated with the synthesized video segment; and render the synthesized video segment that was matched to the one or more viewers.

The system 700 includes an accessing component 720. The accessing component 720 can include functions and instructions for accessing a livestream, wherein the livestream features a host and is viewed by one or more viewers. In embodiments, the livestream can be hosted by an ecommerce website, a social media network site, etc. The accessing includes all images, videos, audio, text, chats, media, and products for sale contained in the livestream.

The system 700 includes an analyzing component 730. The analyzing component 730 can include functions and instructions for analyzing audio from the livestream. In embodiments, the analyzing audio includes natural language processing (NLP). NLP is a category of Artificial Intelligence (AI) concerned with interactions between humans and computers using natural human language. NLP can be used to develop algorithms and models that allow computers to understand, interpret, generate, and manipulate human language. NLP includes speech recognition; text and speech processing; encoding; text classification, including text qualities, emotions, humor, and sarcasm; and language generation and interaction, including dialogue systems, voice assistants, and chatbots. In embodiments, the livestream audio analyzing includes NLP to understand the text and the context of voice and text communication during the livestream. NLP can be used to detect one or more topics discussed by the livestream host and viewers. Evaluating a context of the livestream can include determining a topic of discussion during the livestream; understanding references to and information from other livestreams; highlighting products for sale or product brands; and evaluating livestream hosts associated with a brand, product for sale, or topic. The analyzing includes analyzing viewer interactions with the one or more viewers and with the host of the livestream. The viewer interactions can include questions, responses, or comments that occur during the livestream. The host can be a primary host, a host assistant, multiple hosts, and so on.

In embodiments, the analyzing component 730 includes analyzing one or more images from the livestream, wherein the one or more images comprises a video. In embodiments, the one or more images includes images of the host. In embodiments, the one or more images include images of the one or more viewers. In other embodiments, the analyzing component 730 includes recognizing when the host views a product for sale. In further embodiments, the analyzing component 730 includes recognizing when the host demonstrates a product for sale. In still other embodiments, the analyzing component 730 further comprises identifying a confused look from the one or more viewers.

The identifying can help to determine when a synthetic video segment is needed to clarify a topic or give more information about a product for sale. Identifying confusion can also be used in determining the quality of the matching of a synthetic video segment to a viewer question or host comment. The analyzing component 730 further comprises evaluating a context of the livestream, wherein the context includes one or more products for sale or a brand. In embodiments, the analyzing component 730 further comprises evaluating other livestreams. In still other embodiments, the analyzing component 730 further comprises evaluating a topic of discussion for the livestream. In some embodiments, the context can include a specific host. The livestream audio analyzing, image analyzing, and evaluating content can all be used to identify discussion topics, host qualities and interests, products for sale, subject matter, and so on that can generate questions to be answered by the livestream host or assistant. The potential questions can be identified by direct questions asked by livestream participants; comments made in livestream chats or verbal exchanges; demonstrations, looks, or gestures made by the livestream host; and so on. The analyzing of audio and images can be accomplished in real time and can encompass all forms of media content contained in the livestream from the start of the event.

The system 700 includes a predicting component 740. The predicting component 740 can include functions and instructions for predicting a plurality of potential questions from the one or more viewers, wherein the predicting is based on the audio that was analyzed. Products for sale can create potential questions about how they can be used, what colors or sizes are available, physical size and weight of the products, and so on. Questions about a livestream host can be predicted in relation to topics being discussed during a livestream. Questions can be generated about topics discussed during a livestream as well. In embodiments, the potential questions can be generated from a database of questions asked during other livestreams, comments made during the livestream, or can be generated by an AI machine learning model.

The system 700 includes a generating component 750. The generating component 750 can include functions and instructions for generating an answer to each potential question within the plurality of potential questions, wherein the generating is based on a large language model (LLM) neural network. A large language model is a type of machine learning model that can perform a variety of natural language (NLP) tasks, including generating and classifying text, answering questions in a human conversational manner, and translating text from one language to another. The machine learning model in a LLM neural network can include hundreds of billions of parameters. LLMs are trained with millions of text entries, including entire books, speeches, scripts, and so on. In embodiments, the LLM is associated with a generative Artificial Intelligence (AI) chatbot. Generative artificial intelligence (AI) is a type of AI technology that can generate various types of content including text, imagery, audio, and synthetic data. The most recent versions of generative AI use generative adversarial networks (GANs) to create the content. A generative adversarial network uses samples of data, such as sentences and paragraphs of human-written text, as training data for a model. The training data is used to teach the model to recognize patterns and generate new examples based on the patterns. In embodiments, each potential question within the plurality of potential questions can be fed into an LLM/generative AI chatbot and the answer can be captured and used to create a video response to the potential question.

The system 700 includes a creating component 760. The creating component 760 can include functions and instructions for creating a synthesized video segment for each answer to each potential question within the plurality of potential questions, wherein the synthesized video segment is associated with the potential question that was answered. In embodiments, each synthesized video segment that was matched comprises a performance by the livestream host or an assistant. An image of the livestream host can be captured from the livestream in real time and from other sources. The media sources can include one or more photographs, videos, livestream events, and livestream replays, including the voice of the livestream host. In some embodiments, a photorealistic representation of the livestream host can include a 360-degree representation. The livestream host can comprise a human host that can be recorded with one or more cameras, including videos and still images, and microphones for voice recording. The recordings can include one or more angles of the human host and can be combined to comprise a dynamic 360-degree photorealistic representation of the human host. The voice of the human host can be recorded and included in the representation of the human host. The images of the livestream host can be isolated and combined in an AI machine learning model into a 3D model that can be used to generate a video segment in which the synthesized livestream host responds to the potential questions using the answers generated by the LLM/generative AI chatbot. The voice used by the livestream host can be synthesized from voice samples captured from the livestream and other audio sources. In some embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. In some embodiments, a 3D model of the livestream host or assistant can be used as the performer of animation generated by a game engine, after the sequence of movements and dialogues have been decided. The result is a synthesized performance by the livestream host model, combining animation generated by a game engine and the 3D model of the individual, including the voice of the individual. In some embodiments, the livestream host or assistant can be a representation of another individual or an animated character. After the synthesized video segment has been created, it can be stored in a library of short-form videos for use in responding to real-time questions during the livestream. The synthesized video segment can include metadata that includes the related topic, subject matter, product, historical timeframe, region, names of related parties, and so on. The metadata can be used to match the synthesized video segment to a comment or question made by a viewer during the livestream.

The system 700 includes a storing component 770. The storing component 770 can include functions and instructions for storing the video segment associated with each potential question from the plurality of potential questions. After the synthesized video segment has been created, it can be stored in a library of short-form videos for use in responding to real-time questions during the livestream. The synthesized video segment can include metadata that includes the related topic, subject matter, product, historical timeframe, region, names of related parties, and so on. The metadata can be used to match the synthesized video segment to a comment or question made by a viewer during the livestream.

The system 700 includes a detecting component 780. The detecting component 780 can include functions and instructions for detecting a real-time question from the one or more viewers within the livestream. As the livestream progresses, viewers can make comments or ask questions of one another and the livestream host or assistant. The audio from the livestream, and the text of livestream chats, can be analyzed by an AI machine learning model including NLP and used to identify questions to be answered by the livestream host or assistant. The detecting can include questions or comments made by the livestream host or assistant as the livestream progresses.

The system 700 includes a matching component 790. The matching component 790 can include functions and instructions for matching a real-time question with a synthesized video segment that was stored, wherein the matching is based on the potential question that was associated with the synthesized video segment. In embodiments, the matching is based on a fuzzy matching algorithm working with natural language processing. Fuzzy matching, also called approximate string matching, is a technique that helps to identify elements in strings of text that are similar but not necessarily exactly the same. The comparison of comments or questions captured from a livestream to metadata or text included in the potential question video segments can result in a set of most likely matches to topics or subjects identified in the viewer question or comment. Each synthesized video that was matched can comprise a performance by the livestream host or an assistant. In embodiments, the assistant is a representation of an individual. In other embodiments, the assistant is an animated character. In still other embodiments, the matching can include one or more synthesized videos that were generated in response to potential questions associated with a previous livestream or livestream replay.

The system 700 includes a rendering component 792. The rendering component 792 can include functions and instructions for rendering the synthesized video segment that was matched to the one or more viewers. In embodiments, the rendering can occur while the host is displayed in the livestream. The livestream host can be a human or synthesized host. The determining of at least one insertion point for the synthesized video segment is accomplished by analyzing the livestream. The analyzing is accomplished by AI machine learning and can include detecting questions generated by the host or viewer participants in the livestream or detecting one or more subject matters discussed by the host. The object of the analysis is to identify specific points in the livestream where the synthesized video segment can be added into the real-time replay seamlessly, so that the viewers are unaware of the transition from the livestream replay to the synthesized video. In some embodiments, the determining of the insertion point can form a response to the interaction of viewers of the livestream. As the livestream is played, viewers can ask for more information about a product for sale that is highlighted by the host, can interact on a particular subject being discussed by the host, etc. If a viewer completes a purchase, donates, or signs up for a promotion, the livestream operator can insert a recognition by the host using a synthesized video segment. AI-generated speech can be used to add the username of the viewer as provided in a text interaction during the livestream event, etc.

In embodiments, inserting the synthesized video segment is accomplished by stitching the synthesized video segment into the prerecorded livestream at the one or more insertion points. Video stitching is the process of combining two or more videos so that they play one after the other without a noticeable transition from one video to the next. For example, a prerecorded livestream can include a series of frames A, B, C, D, and E. A synthesized video segment can include a series of frames L, M, and N. The livestream operator selects frame C as the insertion point for the synthesized video segment. The result of the insertion process is the series of frames A, B, C, L, M, N, D, and E. The stitching occurs at one or more boundary frames at the one or more insertion points between the synthesized video and the livestream. The stitching process may use copies of frames from other points in the livestream or synthesized video. It may repeat frames within either video or delete frames as needed in order to produce the least noticeable transition from the livestream to the synthesized video.

The system 700 can include a computer program product embodied in a non-transitory computer readable medium for video generation, the computer program product comprising code which causes one or more processors to perform operations of: accessing a livestream, wherein the livestream features a host and is viewed by one or more viewers; analyzing audio from the livestream; predicting a plurality of potential questions from the one or more viewers, wherein the predicting is based on the audio that was analyzed; generating an answer to each potential question within the plurality of potential questions, wherein the generating is based on a generative artificial intelligence (AI) chatbot; creating a synthesized video segment for each answer to each potential question within the plurality of potential questions, wherein the synthesized video segment is associated with the potential question that was answered; storing the video segment associated with each potential question from the plurality of potential questions; detecting a real-time question from the one of more viewers within the livestream; matching the real-time question with a synthesized video segment that was stored, wherein the matching is based on the potential question that was associated with the synthesized video segment; and rendering the synthesized video segment that was matched to the one or more viewers.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video generation comprising:
accessing a livestream, wherein the livestream features a host and is viewed by one or more viewers;
analyzing audio from the livestream;
predicting a plurality of potential questions from the one or more viewers, wherein the predicting is based on the audio that was analyzed;
generating an answer to each potential question within the plurality of potential questions, wherein the generating is based on a large language model (LLM) neural network;
creating a synthesized video segment for each answer to each potential question within the plurality of potential questions, wherein the synthesized video segment is associated with the potential question that was answered;
storing the video segment associated with each potential question from the plurality of potential questions;
detecting a real-time question from the one of more viewers within the livestream;
matching the real-time question with a synthesized video segment that was stored, wherein the matching is based on the potential question that was associated with the synthesized video segment; and
rendering the synthesized video segment that was matched to the one or more viewers.

2. The method of claim 1 wherein the analyzing includes analyzing one or more images from the livestream.

3. The method of claim 2 wherein the one or more images comprises a video.

4. The method of claim 2 wherein the one or more images include images of the host.

5. The method of claim 4 further comprising recognizing when the host views a product for sale.

6. The method of claim 4 further comprising recognizing when the host demonstrates a product for sale.

7. The method of claim 2 wherein the one or more images include images of the one or more viewers.

8. The method of claim 7 further comprising identifying a confused look from the one or more viewers.

9. The method of claim 1 wherein the analyzing includes analyzing viewer interactions of the one or more viewers and with the host of the livestream.

10. The method of claim 9 wherein the viewer interactions include questions, responses, or comments that occur during the livestream.

11. The method of claim 1 wherein each synthesized video segment that was matched comprises a performance by an assistant.

12. The method of claim 11 wherein the assistant is a representation of an individual.

13. The method of claim 11 wherein the assistant is an animated character.

14. The method of claim 11 wherein the assistant is the host.

15. The method of claim 1 wherein the matching is based on a fuzzy matching algorithm.

16. The method of claim 1 wherein the analyzing audio includes natural language processing (NLP).

17. The method of claim 1 wherein the analyzing audio further comprises detecting a topic being discussed by the host.

18. The method of claim 1 wherein the analyzing further comprises evaluating a context of the livestream.

19. The method of claim 18 wherein the context includes other livestreams.

20. The method of claim 18 wherein the context includes one or more products for sale or a brand.

21. The method of claim 18 wherein the context includes a topic of discussion in the livestream.

22. The method of claim 1 wherein the rendering occurs while the host is displayed in the livestream.

23. The method of claim 1 wherein the matching includes one or more synthesized videos that were generated in response to potential questions associated with a previous livestream or livestream replay.

24. The method of claim 1 wherein the generating includes the livestream as an input to the LLM neural network.

25. A computer program product embodied in a non-transitory computer readable medium for video generation, the computer program product comprising code which causes one or more processors to perform operations of:
accessing a livestream, wherein the livestream features a host and is viewed by one or more viewers;
analyzing audio from the livestream;
predicting a plurality of potential questions from the one or more viewers, wherein the predicting is based on the audio that was analyzed;
generating an answer to each potential question within the plurality of potential questions, wherein the generating is based on a large language model (LLM) neural network;
creating a synthesized video segment for each answer to each potential question within the plurality of potential questions, wherein the synthesized video segment is associated with the potential question that was answered;
storing the video segment associated with each potential question from the plurality of potential questions;
detecting a real-time question from the one of more viewers within the livestream;
matching the real-time question with a synthesized video segment that was stored, wherein the matching is based on the potential question that was associated with the synthesized video segment; and
rendering the synthesized video segment that was matched to the one or more viewers.

26. A computer system for video generation comprising:
a memory which stores instructions;
one or more processors coupled to the memory wherein the one or more processors, when executing the instructions which are stored, are configured to:
access a livestream, wherein the livestream features a host and is viewed by one or more viewers;
analyze audio from the livestream;
predict a plurality of potential questions from the one or more viewers, wherein predicting is based on the audio that was analyzed;
generate an answer to each potential question within the plurality of potential questions, wherein generating is based on a large language model (LLM) neural network;
create a synthesized video segment for each answer to each potential question within the plurality of potential questions, wherein the synthesized video segment is associated with the potential question that was answered;
store the video segment associated with each potential question from the plurality of potential questions;
detect a real-time question from the one of more viewers within the livestream;
match the real-time question with a synthesized video segment that was stored, wherein matching is based on the potential question that was associated with the synthesized video segment; and
render the synthesized video segment that was matched to the one or more viewers.
